(19) United States
(12) Patent Application Publication
(10) Pub. No.: US 2016/0224235 A1
(43) Pub. Date: Aug. 4, 2016

(54) TOUCHLESS USER INTERFACES

(71) Applicant: Elliptic Laboratories AS, Oslo (NO)

(72) Inventors: Erik FORSSTRÖM, Oslo (NO); Hans Jørgen BANG, Oslo (NO)

(21) Appl. No.: 15/043,411

(22) Filed: Feb. 12, 2016

Related U.S. Application Data
(63) Continuation of application No. PCT/GB2014/052396, filed on Aug. 5, 2014.

(30) Foreign Application Priority Data
Aug. 15, 2013 (GB) 1314625.3
Apr. 1, 2014 (GB) 1405833.3

(51) Int. Cl. G06F 3/0488; G06F 3/01; G06F 3/041; G06F 3/0484

(52) U.S. Cl. CPC G06F 3/04883; G06F 3/04845; G06F 3/017; G06F 3/0416; G06F 2203/04108

(57) ABSTRACT

An electronic device (2) comprises a touch-sensitive screen (8) and a touchless detecting system for detecting movement of an input object (10). The device (2) is configured to detect a touchless movement of an input object (10) towards or away from the screen (8) and is arranged to change at least one aspect of the appearance of a graphical user interface element (6) as the distance from the touch-sensitive screen (8) to the input object (10) changes, wherein the change in the graphical user interface element (6) is independent of the coordinates of the input object (10) in a plane parallel to the screen (8).

### RELATED APPLICATION

This application is a continuation of International Application No. PCT/GB2014/052396, filed on Aug. 5, 2014, which is incorporated herein by reference in its entirety.

This invention relates to the control of electronic devices through the use of signals, particularly ultrasonic signals, reflected from an object such as a human hand.

In recent years, there has been a move in electronic devices away from a keyboard to more ‘natural’ methods of control. This has been introduced using touchless technologies, in which hand gestures can be tracked in order to control the device. Ultrasonic signals can be used for this type of tracking, using transducers to send and receive reflections from an input object. The reflections from an input object can be recorded and analysed in order to control a device. An example of the use of touchless technologies to control a mobile device can be found in WO 2009/115799, which describes the use of image processing techniques on impulse response images in order to determine input motions carried out by a user.

It is envisaged that at least some devices will have both touch and touchless interfaces. While these two interfaces can be used separately, when they are both provided on the same device, the Applicant has recognised that it may be beneficial to integrate them, allowing a user to transition smoothly between touchless and touch interactions.

When viewed from a first aspect, the invention provides an electronic device comprising a touch-sensitive screen and a touchless detecting system for detecting movement of an input object; the device being configured to detect a touchless movement of an input object towards or away from the screen and arranged to change at least one aspect of the appearance of a graphical user interface element as the distance from the touch-sensitive screen to the input object changes, wherein the change in the graphical user interface element is independent of the coordinates of the input object in a plane parallel to the screen.

This aspect extends to a method of operating an electronic device comprising a touch-sensitive screen and a touchless detecting system for detecting movement of an input object comprising detecting a touchless movement of an input object towards or away from the screen and changing at least one aspect of the appearance of a graphical user interface element as the distance from the touch-sensitive screen to the input object changes, wherein the change in the graphical user interface element is independent of the coordinates of the input object in a plane parallel to the screen.

This aspect further extends to computer software for operating an electronic device comprising a touch-sensitive screen and a touchless detecting system for detecting movement of an input object comprising logic for detecting a touchless movement of an input object towards or away from the screen and logic for changing at least one aspect of the appearance of a graphical user interface element as the distance from the touch-sensitive screen to the input object changes, wherein the change in the graphical user interface element is independent of the coordinates of the input object in a plane parallel to the screen.

Thus it can be seen that the movement of an input object relative to the screen causes a response from a graphical user interface (GUI) element. Changing at least one aspect of the GUI element according to the motion of the input object allows the user to discover possible interactions which they may not have been aware of, for example by displaying a menu or scroll bars. However, it is not important which part of the screen is approached, as the reaction of the GUI element does not take into account the direction of approach of the input object or the part of the screen being approached. As an interaction region for a touchless detecting system may be wider than the screen, the input object may not approach the screen from directly above it; it may instead approach diagonally or from one side of the device. Each of these distances can be measured by the touchless detecting system, and the distance to the screen is the feature which determines the change of an aspect of the appearance of the GUI element.

The distance between the input object and the screen could be defined in a number of ways—for example the shortest distance from the input object to any point on the screen or the distance to a specific point on or adjacent the screen such as a transducer. In addition or alternatively, the distance may be defined as the distance from a specific transmitter to the input object and back to a specific receiver. This may allow the distance to be measured with a minimal configuration consisting of one transmitter and one receiver or even a single dual-purpose transceiver. Preferably however the distance is defined as the distance in a direction normal to the screen—i.e. the ‘z’ axis. It will be appreciated by the skilled person that when the distance is defined other than in a direction normal to the screen, the coordinates of the input object in a given plane parallel to the screen will automatically change when the defined distance changes. However in accordance with the invention the GUI element appearance change is otherwise independent of said coordinates.

Changing an aspect of the appearance of the GUI element means that the GUI element may react to a gradual change in distance between the input object and the screen, rather than to the input object passing a single threshold distance. The GUI element may, in a set of embodiments change its appearance gradually—e.g. due to a movement by the user which indicates they are likely to use or stop using the touch-sensitive screen. This increases the ease of use of the device, making the type of interactions that are available more intuitive to a user.

In a set of embodiments, the GUI element gradually appears or disappears based on the detection of a touchless movement. This may be used to add extra functionality to the operation of the device, for example bringing up on-screen keyboards or control buttons which had not previously been visible. It also allows for such items to be hidden until required, preventing them taking up space on the screen and allowing for an increased viewing area. These items may appear over the previous screen, or alternatively the screen may be pushed to the side or compressed to make space for the new GUI element. The change in the GUI element appearance may involve additionally or alternatively changing another aspect of the appearance of a GUI element for example by changing the colour, changing the focus (i.e. from blurry to sharp focus), changing the size or changing the shape of the GUI element.

In a set of embodiments, the GUI element changes size based on the distance between the touch-sensitive surface and the input object carrying out the movement. This can allow elements to start at a small size, and then increase in size to a point where the user is able to interact with them as the hand approaches the screen. This may increase the viewing region while touch interactions are not required by only increasing the prominence of elements when they will be interacted with. The element size may be inversely proportional to the distance between the input object and the screen, but this may only be for a portion of the distance, and may not be over the entire range of motion of the hand.

In a set of embodiments the appearance of the GUI element changes in a discrete manner as the distance of the input object changes. This could be instead of or in addition to gradual, continuous changes, For example different GUI elements could be displayed for certain distance ranges to give a user an impression of the user interface having different layers. One or more of these could also change in response to movement within the associated distance range, or the appearance could remain unchanged within each range.

Viewing the invention from another aspect there is provided an electronic device comprising a touch-sensitive screen and a touchless detecting system for detecting movement of an input object; the device being configured to detect a touchless movement of an input object towards or away from the screen and arranged to change at least one aspect of the appearance of a graphical user interface element as the distance from the touch-sensitive screen to the input object changes, wherein the change in the graphical user interface element is independent of the coordinates of the input object in a plane normal to the distance to the screen. This aspect of the invention extends to a corresponding method and computer software.

The appearance of the GUI element may be dependent only on the distance between the input object and the screen, but in other embodiments it is also dependent on other factors. For example, in a set of embodiments the appearance is also dependent on a direction in which the input object is moving. For example, in a set of such embodiments the change in appearance may take place only if the input object is moving in a predetermined direction or range of directions relative to the screen.

This is novel and inventive in its own right and thus when viewed from a second aspect, the invention provides an electronic device comprising a touch-sensitive screen and a touchless detecting system for detecting movement of an input object; the device being configured to detect a touchless movement of an input object and change at least one aspect of the appearance of a GUI element upon detection of a movement of the input object in a predetermined direction or range of directions relative to the touch-sensitive screen.

This aspect also extends to a method of operating an electronic device comprising a touch-sensitive screen and a touchless detecting system for detecting movement of an input object comprising detecting a touchless movement of an input object and changing at least one aspect of the appearance of a GUI element upon detection of a movement of the input object in a predetermined direction or range of directions relative to the touch-sensitive screen.

The aspect further extends to computer software for operating an electronic device comprising a touch-sensitive screen and a touchless detecting system for detecting movement of an input object comprising logic for detecting a touchless movement of an input object and logic for changing at least one aspect of the appearance of a GUI element upon detection of a movement of the input object in a predetermined direction or range of directions relative to the touch-sensitive screen.

The predetermined direction(s) may be in any direction, but preferably it is perpendicular to the screen. This limits the direction of movement that must be recognised as motion in other directions, e.g. parallel to the screen, may be ignored. This may reduce the processing power needed to operate the device. In addition, it may allow the device to separate general touchless gestures from those in which the user aims to interact with the touch-sensitive surface.

In a set of embodiments the behaviour of the screen is direction dependent, reacting only to motion of the input object substantially perpendicular to the screen. The device may react to any movement which is substantially perpendicular, i.e. between 80 and 100° from the screen, but preferably it responds to movements between 85 and 95°. This can be particularly useful when linking from touchless to touch interactions, as it can be used to cause objects to appear on screen, making them available for user interaction, and can alter their size such that they reach an easily accessible size. This allows for a smooth transition between a touchless gesture which generates or alters a GUI element and a touch interaction with said element. The GUI element may be a keyboard, a menu bar, a scroll bar/wheel, or application specific elements such as a play button for a music function.

Changing the GUI element upon detection of movement may comprise making a change once one or more threshold distances between the screen and the input object is crossed. This could be used to bring GUI elements to the front of the display and make them accessible when a perpendicular movement is detected passing a certain point, and optionally to change the GUI element(s) when a different point is passed. Alternatively, in a set of embodiments, changing the GUI element upon detection of movement comprises changing an aspect of the appearance of the GUI element as the distance from the touch-sensitive screen to the input object changes, i.e. allowing gradual changes as in accordance with the first aspect of the invention.

Preferably, the input object must be within a set range of distances for the GUI element to be able to change dependent on the movement of the input object. This can prevent movements which are over a certain distance from the device from initiating changes to the GUI, and reducing the influence of background movement. If the device were to have a large range, background movements not intended to control the device could impact on the control of the device and increased processing would be needed in order to determine the intended input object and to resolve its position. It also means that there could be a short-range cut off, e.g. such that a hand supporting the device could not accidentally change the GUI. The device may react to movements between 0.5 and 30 cm from the device, further between 1 and 15 cm. However, it is not necessary for the device to change continually within this range, and in a set of embodiments the GUI element only changes size when the input object moves through a smaller range of distances. This may for example be over the central point of the device interaction range, causing the element to grow rapidly in this range and then maintain its final size as the input object continues to approach the screen.

In a set of embodiments, there is a minimum speed which an input object must exceed in order for the GUI element to change an aspect of its appearance. For example, the input object must be moving at more than 2 cm/s for this to happen. In addition, preferably the speed is less than a maximum, e.g. 20 cm/s. This helps to prevent the device registering spurious movements, for example thinking two different input objects are actually one input object moving at high speed.

In a set of embodiments, the device is arranged to activate the touch-sensitive surface when the input object is at a predetermined distance from the surface. This may, for example, correspond to the appearance of a GUI element or the GUI as a whole increasing in brightness. This can be used to reduce processing power and increase battery life by deactivating the touch-sensitive surface until an appropriate touchless gesture is detected.

The ability to detect touchless gestures may be deactivated when the touch-sensitive surface is activated, but in a set of embodiments, the device is arranged to continue to detect touchless gestures once the GUI element has appeared. This stops the user from being restricted to using the touch screen, allowing them to carry out other gestures for example scrolling through text using a touchless gesture once a keypad has appeared.

Some embodiments of the invention will now be described, by way of example only, with reference to the accompanying drawings in which:

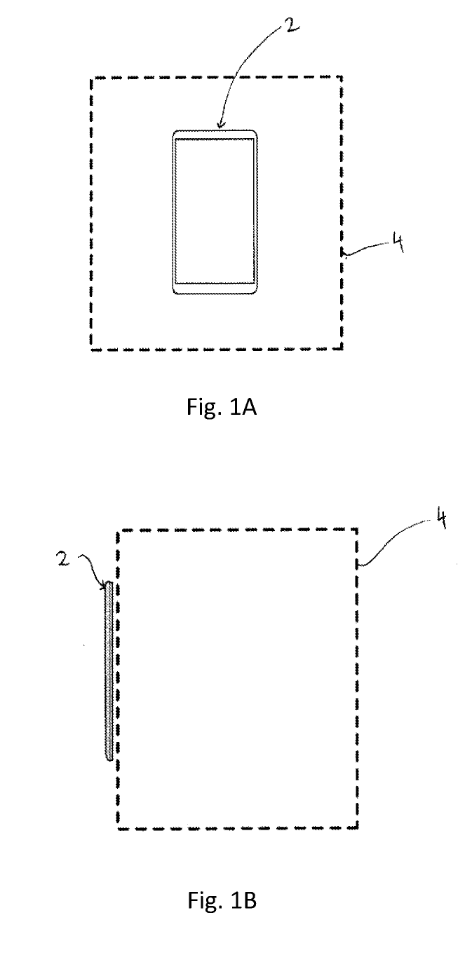

FIGS. 1A and 1B show the region in which touchless gestures can be detected;

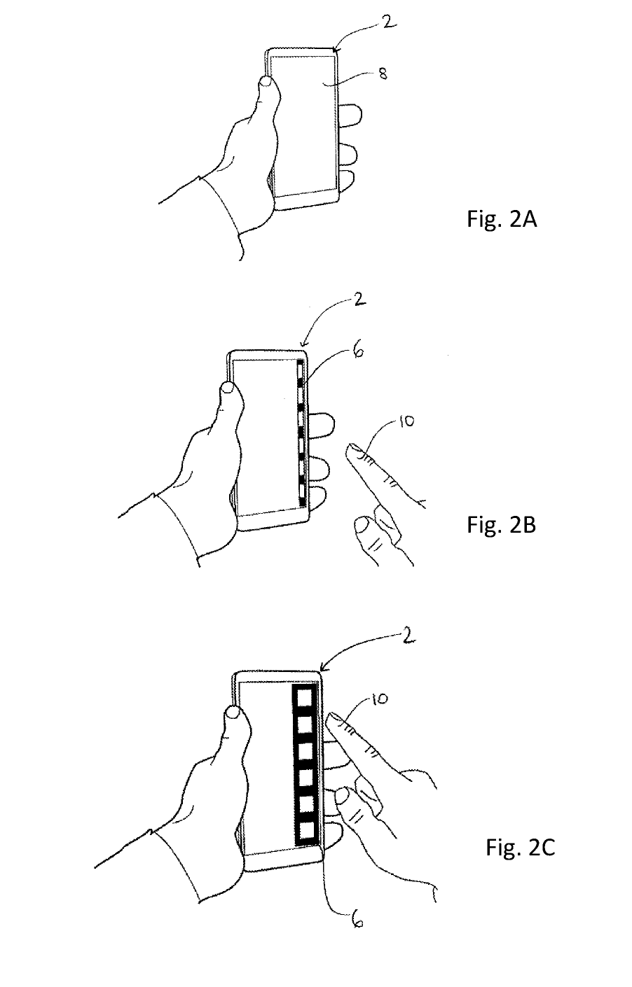

FIGS. 2A-C show an embodiment of the invention in which a touchless gesture alters a GUI element on a screen; and

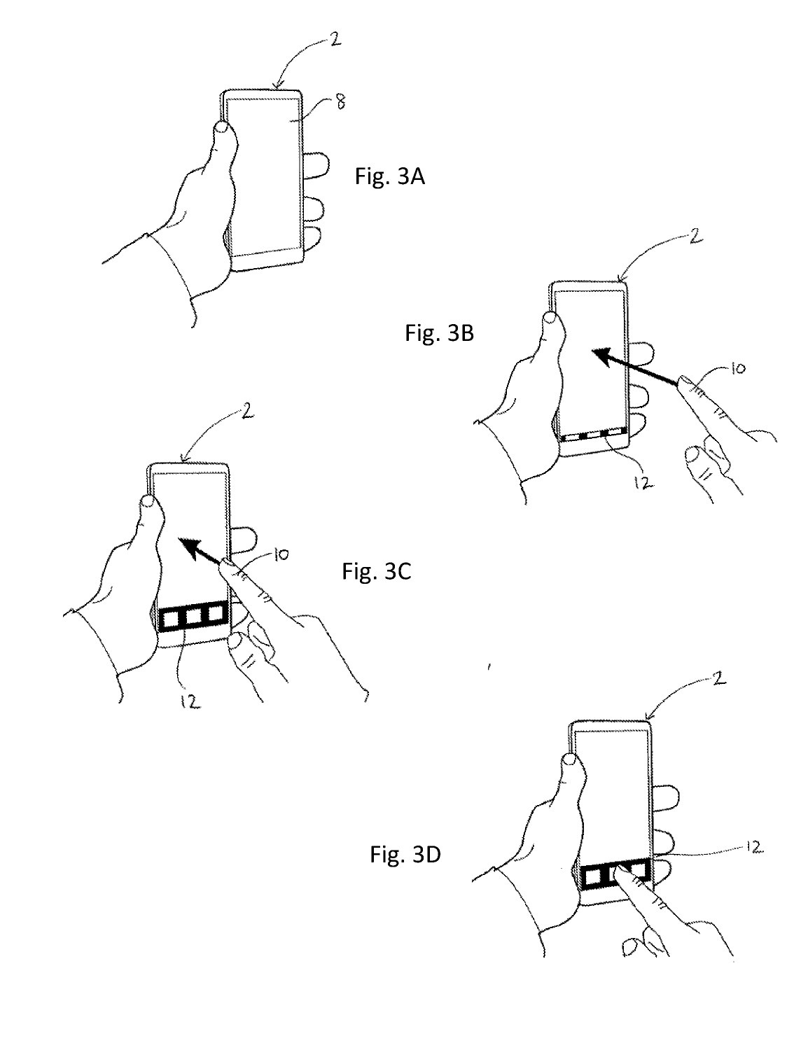

FIGS. 3A-D show an alternative embodiment of the invention in which a directional gesture is used to change a GUI element.

An exemplary implementation of touchless control of user interfaces is described below, on which embodiments of the invention may be based. Within a bezel surrounding a touch-screen on a portable device, for example a smart phone or tablet, are a number of ultrasonic transmitters and receivers. These could be dedicated ultrasonic transducers or they could also be used as audible loudspeakers and microphones when driven at the appropriate frequencies. A signal generator generates signals at ultrasonic frequencies which are converted to ultrasonic waves by an ultrasonic transmitter. These waves bounce off an object to be tracked, such as a hand, as well as bouncing off any other obstacles in the vicinity. The reflected energy is received by one or more ultrasound receivers which convert the energy back into analogue electrical signals which are passed to a processor. The analogue signals output by the ultrasonic receiver are used to calculate impulse responses for the channel comprising: the ultrasonic transmitter, the imaging field containing the object of interest and the ultrasonic receiver. As described in WO 2009/115799, the processor computes impulse responses, carries out filtering, combines impulse responses images to become 2D or 3D images etc, so as ultimately to determine the motion of the object. The information about the presence and position of the object is passed to the touch-sensitive display, causing it to change according to the input motions of the user.

FIGS. 1A and 1B show a device 2 which can be operated in accordance with the invention. The region 4 shown in FIGS. 1A and 1B details the region in which touchless movement of the input object (e.g. a finger) can be detected. As can be seen, the region 4 covers an area larger than the device which extends from the plane of the device towards the user. This gives a larger control region than would be achieved simply through touch-sensitive controls, and can also allow a directional element to be included as the direction from which the finger approaches the device can be registered. Touchless gesture recognition can be used to add functionality to a device, allowing for intuitive movements to be used for control. It does not need to be used to replace touch-screen or button functionality. As the detection area is not limited to two dimensions, a greater range of input motions can be detected, allowing the user more freedom to interact with the device.

FIGS. 2A-C demonstrates an embodiment of the first aspect of the invention in which a GUI element 6 changes appearance depending on the distance from the screen 8 to the finger 10. In FIG. 2A, a portable device 2 which has both touch and touchless capabilities is seen. This device 2 includes a number of ultrasonic transducers around the edges of the screen 8, allowing for touchless motions to be detected in the regions 4 shown in FIGS. 1A and 1B. In FIG. 2B, the user has begun to move a finger 10 towards the screen 8, causing a scroll bar 6 to appear along the side of the screen 8. This has appeared over the original screen content, but could alternatively shift the previous screen off to the left, to be returned to its original place when the scroll bar is no longer needed. While the finger 10 is still quite far from the screen 8, the scroll bar 6 has just appeared and is still a small size. However, as can be seen from FIG. 2C, as the finger 10 gets closer to the screen 8, the scroll bar 6 increases in size, inversely proportional to the distance from the screen 8. The position of the finger over the screen has no impact on the appearance of the scroll bar, it is only dependent on the distance to the screen. This can be used to show a user intuitively which control actions may be used, in this case either a touch action or touchless gesture to scroll through the screen being displayed. In an alternative embodiment, the touchless gesture may instead cause a number of control buttons to be displayed, which the user is able to press on the screen. In yet another alternative embodiment, different GUI elements appear as the finger moves closer to the screen to give the user the impression of the interface having a number of different layers. These might be, for example, notifications, calendar events, open applications or map layers.

FIGS. 3A-D shows an embodiment of the second aspect of the invention, in which the control of the GUI element 12 is direction dependent. As can be seen, in FIG. 3a there are no objects visible on the screen 8. However, as a finger 10 moves towards the screen 8 in a perpendicular direction, a menu bar 12 begins to appear, as seen in FIG. 3B. This menu bar 12 grows in size as the finger 10 gets closer to the screen 8 (see FIG. 3C) until it reaches its full size. At this stage, the finger 10 will be sufficiently close to the screen 8 that the user can use touch interactions to control the device 2, as seen in FIG. 3D. Alternatively, the menu bar may reach its full size at an earlier point, with the growth of the object dictated by movement over a smaller subset of distances.

The growth allows for a smooth transition between the touchless and touch interactions, as the menu bar 12 only appears when necessitated by the touchless movements. The touchless movement towards the screen 8 does not need to be directed towards the touch-sensitive object. As long as it is a perpendicular motion, the reaction of the screen is independent of the exact position in a plane parallel to the screen. While these touchless movements may be used to allow the user to interact with the touch screen, in a set of embodiments the user may still be able to use touchless gestures once a GUI element has changed appearance due to the movement of an input object. The activation of the touch-screen may not automatically deactivate the touchless detection system, allowing both techniques to be used to control the device.

We claim:

1. An electronic device comprising a touch-sensitive screen and a touchless detecting system for detecting movement of an input object; the device being configured to detect a touchless movement of an input object towards or away from the screen and arranged to change at least one aspect of the appearance of a graphical user interface element as a distance from the touch-sensitive screen to the input object changes only if the input object exceeds a minimum speed, wherein the change in the graphical user interface element is independent of the coordinates of the input object in a plane parallel to the screen.

2. The electronic device as claimed in claim 1, wherein the graphical user interface element gradually appears or disappears based on the detection of the touchless movement.

3. The electronic device as claimed in claim 1, wherein the graphical user interface element changes size based on the distance between the screen and the input object.

4. The electronic device as claimed in claim 1, wherein the appearance of the graphical user interface element changes in a discrete manner as the distance of the input object changes.

5. The electronic device as claimed in claim 1, wherein the distance is defined as a shortest distance from the input object to any point on the screen.

6. The electronic device as claimed in claim 1, wherein the distance is defined as a distance from the screen to said input object in a direction normal to the screen.

7. The electronic device as claimed in claim 1, wherein the distance is defined as a distance from a specific transmitter to the input object and back to a specific receiver.

8. The electronic device as claimed in claim 1, wherein the appearance of the graphical user interface element is also dependent on a direction in which the input object is moving.

9. The electronic device as claimed in claim 1, arranged to change the aspect of the appearance of the graphical user interface element only if the input object is within a set range of distances.

10. The electronic device as claimed in claim 1, arranged to activate the touch-sensitive screen when the input object is at a predetermined distance from the screen.

11. The electronic device as claimed in claim 1, arranged to continue to detect touchless gestures once the aspect of the appearance of the graphical user interface element has changed.

12. A method of operating an electronic device comprising a touch-sensitive screen and a touchless detecting system for detecting movement of an input object comprising detecting a touchless movement of an input object towards or away from the screen and changing at least one aspect of the appearance of a graphical user interface element as the distance from the touch-sensitive screen to the input object changes only if the input object exceeds a minimum speed, wherein the change in the graphical user interface element is independent of the coordinates of the input object in a plane parallel to the screen.

13. The method as claimed in claim 12, comprising the graphical user interface element gradually appearing or disappearing based on the detection of a touchless movement.

14. The method as claimed in claim 12, comprising changing a size of the graphical user interface element changes based on the distance between the screen and the input object.

15. The method as claimed in claim 12, comprising changing the appearance of the graphical user interface element in a discrete manner as the distance of the input object changes.

16. The method as claimed in claim 12, wherein the distance is defined as a shortest distance from the input object to any point on the screen.

17. The method as claimed in claim 12, wherein the distance is defined as a distance from the screen to said input object in a direction normal to the screen.

18. The method as claimed in claim 12, wherein the distance is defined as a distance from a specific transmitter to the input object and back to a specific receiver.

19. The method as claimed in claim 12, wherein the appearance of the graphical user interface element is also dependent on a direction in which the input object is moving.

20. The method as claimed in claim 12, comprising changing the aspect of the appearance of the graphical user interface element only if the input object is within a set range of distances.

21. The method as claimed in claim 12, comprising activating the touch-sensitive screen when the input object is at a predetermined distance from the screen.

22. The method as claimed in claim 12, comprising continuing to detect touchless gestures once the aspect of the appearance of the graphical user interface element has changed.

23. A non-transitory computer-readable medium comprising software for operating an electronic device comprising a touch-sensitive screen and a touchless detecting system for detecting movement of an input object, the software comprising logic detecting a touchless movement of an input object towards or away from the screen and logic changing at least one aspect of the appearance of a graphical user interface element as the distance from the touch-sensitive screen to the input object changes only if the input object exceeds a minimum speed, wherein the change in the graphical user interface element is independent of the coordinates of the input object in a plane parallel to the screen.

24. The non-transitory computer-readable medium as claimed in claim 23, wherein the software comprises logic carrying out the method as claimed in claim 12.
